(19) United States
(12) Patent Application Publication
(10) Pub. No.: US 2011/0085765 A1
(43) Pub. Date: Apr. 14, 2011

(54) OPTICAL FIBER COUPLER

(76) Inventors: Ilan GREENBERG, Haifa (IL); Avram MATCOVITCH, Nesher (IL); Arkady KHACHATUROV, Haifa (IL); Salah Hassoon, Shefar-Am (IL)

(21) Appl. No.: 12/578,031

(22) Filed: Oct. 13, 2009

(51) Int. Cl. G02B 6/38

(52) U.S. Cl. 385/64

(57) ABSTRACT

An optical fiber coupler apparatus for coupling ends of a first and second optical fiber of a substantially equal diameter includes: three cylindrical rods whose longitudinal axes are substantially parallel and in a triangular arrangement, a pressing mechanism, and an urging mechanism. The pressing mechanism presses the rods together, forming a central space that is substantially parallel to the axes, such that an end of the first optical fiber that is inserted into one end of the central space is held substantially collinearly with an end of the second optical fiber that is inserted into an opposite end of the central space. The urging mechanism urges the inserted end of the first optical fiber against the inserted end of the second optical fiber.

### FIELD OF THE INVENTION

The present invention relates to optical fibers. More particularly, the present invention relates to an optical fiber coupler.

### BACKGROUND OF THE INVENTION

The splicing of two identical optical fibers is a delicate task. Appropriate coupling may require the alignment of the two fibers so that their ends are placed in physical contact, with full overlap of their core and cladding. Prior solutions to the problem of coupling and uncoupling of optical fibers have been described. For example, in EP0347118 (The Whitaker Corp.) a connector for end-to-end abutment of two alike optical fibers was described, where an optical fiber can be positioned in the connector for termination thereof. U.S. Pat. No. 5,550,944 (van Woesik et al.) describes a fibre optic coupling assembly that includes a spring loaded coupling lock that locks two fibre connectors together by way of spring balls located in locking grooves.

In the case of multicore optical fibers, angular alignment may be also required.

U.S. Pat. No. 7,500,789 (Grunberg et al.) disclosed a fibre optic coupler assembly for optically aligning a sectioned fibre optic cable with one or more non-concentric fibre optic cores. The assembly comprises a first holder for holding the first end; a second holder for holding the second end coupled to the first end; a retractor for retracting the second end; an aligning unit comprising a resilient construction having a conduit passing through it, for linear alignment of the ends; whereby the first and second ends are coupled by the respective holders and whereby the second end can be linearly aligned in the conduit of the aligning unit, retracted using the retractor, and rotated to obtain rotational alignment of the fiber cores of the ends.

The task of splicing optical fibers of minute dimensions, such as, for example, an optical fiber whose diameter is 1 French (0.33 millimeter), or other sub-millimeter diameters, is much more intricate. For example, in EP 1615562 (by Aharoni at al., Bioscan), the use of an optical fiber of 1 French is described, incorporated in a guidewire for guiding a catheter into a body lumen (such as a blood vessel).

Due to common manufacturing tolerances, it is very difficult to achieve high accuracy optical coupling of sub-millimeter diameter optical fibers. For example, for some optical fiber applications, alignment accuracy may be required within a few micrometers (microns).

It is an object of the present invention to provide an optical fiber coupler for accurate splicing of ends of sub-millimeter diameter axially symmetric optical fibers.

Other objects and advantages of the present invention will become apparent after reading the present specification and considering the accompanying drawings.

### SUMMARY OF THE INVENTION

There is thus provided, in accordance with embodiments of the present invention, an optical fiber coupler apparatus for coupling ends of a first and second optical fiber of a substantially equal diameter. The apparatus includes:
three cylindrical rods, whose longitudinal axes are substantially parallel and in a triangular arrangement;
a pressing mechanism for pressing the rods together, forming a central space that is substantially parallel to the axes, such that an end of the first optical fiber that is inserted into one end of the central space is held substantially collinearly with an end of the second optical fiber that is inserted into an opposite end of the central space; and
an urging mechanism for urging the inserted end of the first optical fiber against the inserted end of the second optical fiber.

Furthermore, in accordance with some embodiments of the present invention, a rod of the three cylindrical rods includes two collinear rod segments.

Furthermore, in accordance with some embodiments of the present invention, the diameters of the rods are substantially equal.

Furthermore, in accordance with some embodiments of the present invention, the pressing mechanism includes two plates that are pressed together.

Furthermore, in accordance with some embodiments of the present invention, one plate of the two plates is provided with a wide groove for confining two rods of the three cylindrical rods, and the other plate of the two plates is provided with a narrow groove for confining one rod of the three cylindrical rods.

Furthermore, in accordance with some embodiments of the present invention, the apparatus includes an elastic element for pressing the plates together.

Furthermore, in accordance with some embodiments of the present invention, the elastic element comprises an O-ring.

There is further provided, in accordance with embodiments of the present invention, a method for coupling ends of a first and second optical fibers of a substantially equal diameter. The method includes:
providing three cylindrical rods, whose longitudinal axes are substantially parallel and in a triangular arrangement;
providing a pressing mechanism for pressing the rods together, forming a central space that is substantially parallel to the axes;
providing an urging mechanism for urging the inserted end of the first optical fiber against the inserted end of the second optical fiber;
inserting an end of the first optical fiber into one end of the central space and an end of the second optical fiber into an opposite end of the central space until the inserted ends meet;
operating the pressing mechanism to press the rods together such that the inserted end of the first optical fiber is held substantially collinearly with the inserted end of the second optical fiber; and
operating the urging mechanism to urge the inserted end of the first optical fiber against the inserted end of the second optical fiber.

Furthermore, in accordance with some embodiments of the present invention, the step of inserting an end of the first optical fiber and of inserting an end of the second optical fiber includes increasing a dimension of the central space in a plane that is substantially perpendicular to the longitudinal axes.

Furthermore, in accordance with some embodiments of the present invention, the pressing mechanism includes two plates that are pressed together, and the step of increasing a dimension of the central space includes increasing the distance between the plates.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A shows a fiber coupler, in accordance with embodiments of the present invention;

FIG. 1B shows the fiber coupler of FIG. 1A with fibers inserted;

FIG. 2A shows the fiber coupler of FIG. 1A with a plate removed, illustrating internal structure;

FIG. 2B shows the internal structure shown in FIG. 2A with more elements removed, further illustrating the arrangement of internal elements;

FIG. 2C is view of the internal structure of FIG. 2A, viewed from a different perspective and with a different plate removed;

FIG. 3 shows a cross section of the fiber coupler shown in FIG. 1A;

FIG. 4A shows two fibers being held by rod segments, in accordance with embodiments of the present invention; and

FIG. 4B is a cross-sectional view of FIG. 4A.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A fiber coupler, in accordance with embodiments of the present invention, accurately splices or couples two thin axially symmetric optical fibers, or similar thin elongated fibers, wires, or structures. Typically, a protective ferrule may be mounted, for example, glued, on those ends of the fibers that are to be coupled to one another. The ferrule may assist in polishing the end of the fiber so as to ensure that the face of the end is perpendicular to the axis of the fiber. Attaching a precisely manufactured ferrule to the end of the fiber may ensure that the diameters of the ends to be coupled are equal. The ferrule may be constructed of a metallic material, such as, for example, zirconium. Typically, the cross sectional shape of the fiber and ferrule is circular.

Effective coupling of the ends of two such fibers may require that the coupled ends be in good contact with one another, with essentially no gap between them. In addition, effective coupling may require that the ends of the two coupled fibers be laterally aligned with one another, such that an acceptable fraction of the ends of the two fibers overlap. This may be especially true where coupled fibers each include several sections for carrying separate signals. For example, an optical fiber may include several concentric layers; each layer intended to carry a separate signal. In such a case, an unacceptable misalignment between the optical fibers may result, for example, in increased insertion loss of a signal transmitted from one fiber to the other, or in excessive cross-talk between signals carried by the different sections.

A fiber coupler, in accordance with embodiments of the present invention, provides for accurate lateral positioning of the ends of each of the two fibers to be coupled, or spliced. A fiber is held in a space formed by three parallel cylindrical rods. Typically, the cylindrical rods have circular cross sections. The longitudinal axes of the cylindrical rods are arranged substantially parallel to one another and in a triangular arrangement. The cylindrical rods are confined to a substantially parallel alignment by a supporting structure with a pressing mechanism that presses the rods toward one another. Pressing the rods toward one another reduces the cross section of an elongated central space formed between the rods.

When inserting the end of a fiber into the elongated central space between the rods, the support structure may be adjusted such that the pressing mechanism reduces the pressing force that is applied to the rods. For example, the supporting structure may be opened slightly to enable the cylindrical rods to move apart from one another by a small amount, increasing a cross sectional dimension (approximately perpendicular to the longitudinal axis) of the central space. An end of a first fiber to be coupled, the end typically including a surrounding ferrule, may then be inserted between the ends of the cylindrical rods. The end of the fiber is inserted such that the fiber is approximately parallel to the cylindrical rods. An end of a second fiber to be coupled to the first, and of the same diameter as the inserted end of the first, may be similarly inserted between the other ends of the cylindrical rods. Reducing the pressing force may reduce friction between a fiber and the cylindrical rods, facilitating insertion. Once the fibers are inserted, the supporting structure may be allowed to close, or the pressing force otherwise increased. Increasing the pressing force may press the cylindrical rods toward one another. Each fiber may then held in a precise lateral position that is determined and fixed by the lines of tangent contact between the fiber and each of the cylindrical rods. Thus, two fiber ends of equal diameter that are inserted between opposite ends of the cylindrical rods may be laterally aligned so that they are collinear with one another.

The ends of the inserted fibers are inserted between the cylindrical rods from opposite ends of the cylindrical rods. The ends of the fibers are inserted until the two ends meet at some location between the ends of the cylindrical rods. Typically, the end of a first fiber is inserted into a first insertion aperture at one end of the fiber coupler. The first insertion aperture is provided with an urging mechanism, for example, an elastic element such as a spring, which is designed to urge a fiber that inserted into the first aperture parallel to the axis of the inserted fiber and the cylindrical rods. The first fiber is coupled to the urging mechanism. A second fiber may be inserted into a second insertion aperture at an opposite end of the fiber coupler. The second fiber may be inserted until the end of the second fiber pushes against the inserted end of the first fiber at the splice. When the second fiber pushes against the end of the first fiber, the urging mechanism resists motion of the first fiber. For example, pushing the end of the second fiber against the end of the first fiber compresses a spring that is coupled to the first fiber. The urging mechanism applies a longitudinal force to the first fiber that maintains contact between the ends of the fibers, preventing a gap from forming between the coupled ends at the splice.

Typically, each cylindrical rod is made of several, typically two, collinearly arranged rod segments. The ends of the two rod segments of a single rod meet near the splice between the two fibers, typically at the proximal end of a ferrule that protects the end of one of the fibers. Thus, one fiber is typically inserted between one set of rod segments of the cylindrical rods, while the other fiber is inserted between the other set of rod segments. The inserted ends of the fibers (typically the distal ends of the ferrules) typically meet and are coupled at a splice point that is located between one of the sets of rod segments. The ends of each rod segment may be tapered at the point where it meets the end of the other collinear rod segment of the cylindrical rod.

Reference is now made to the accompanying figures.

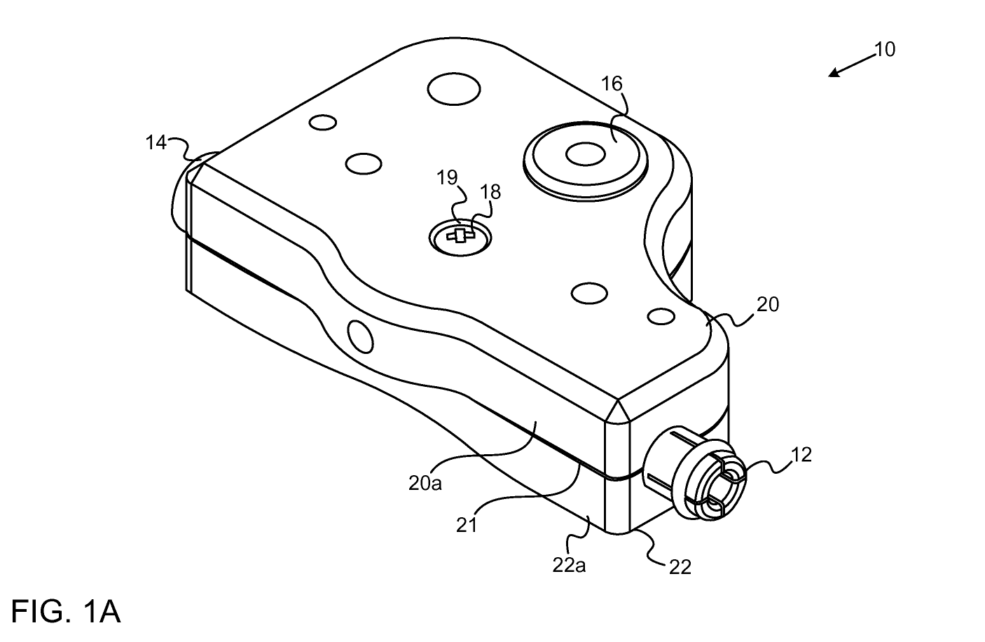

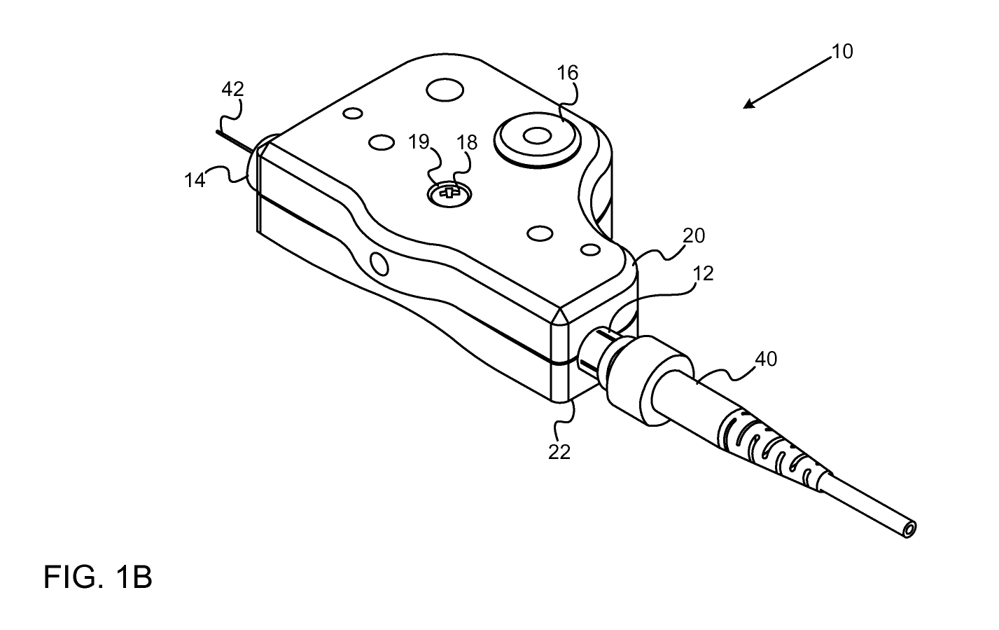

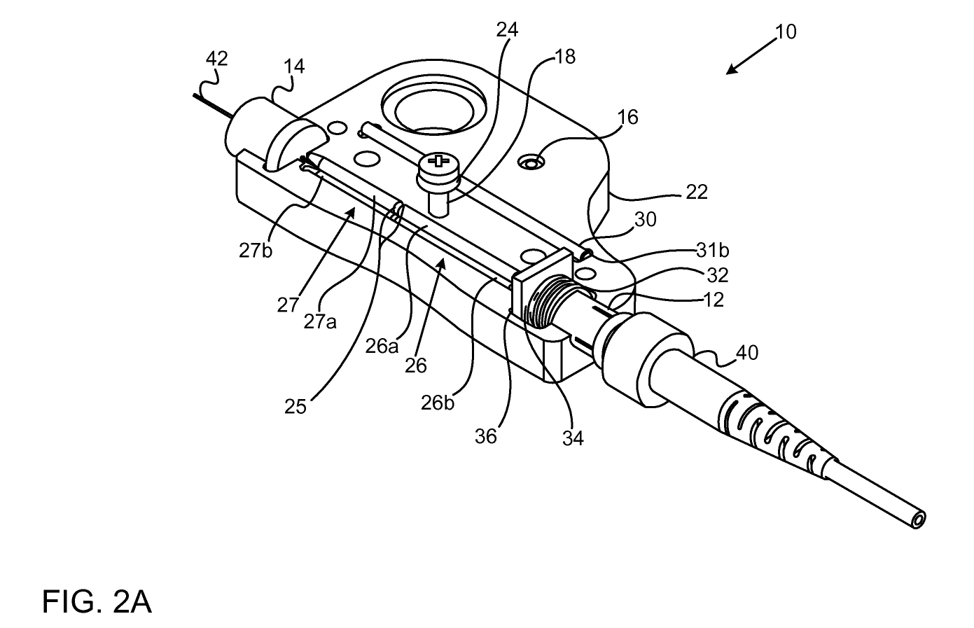

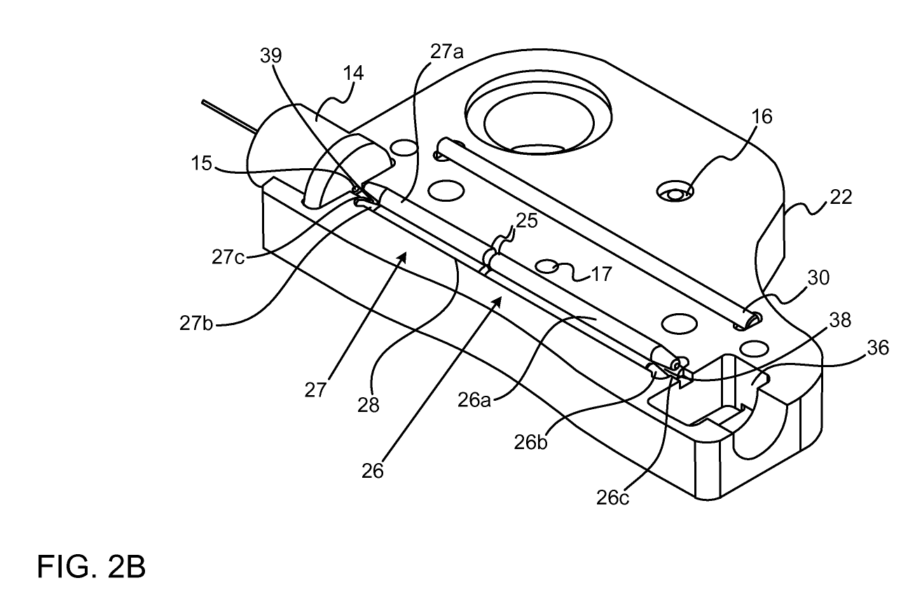

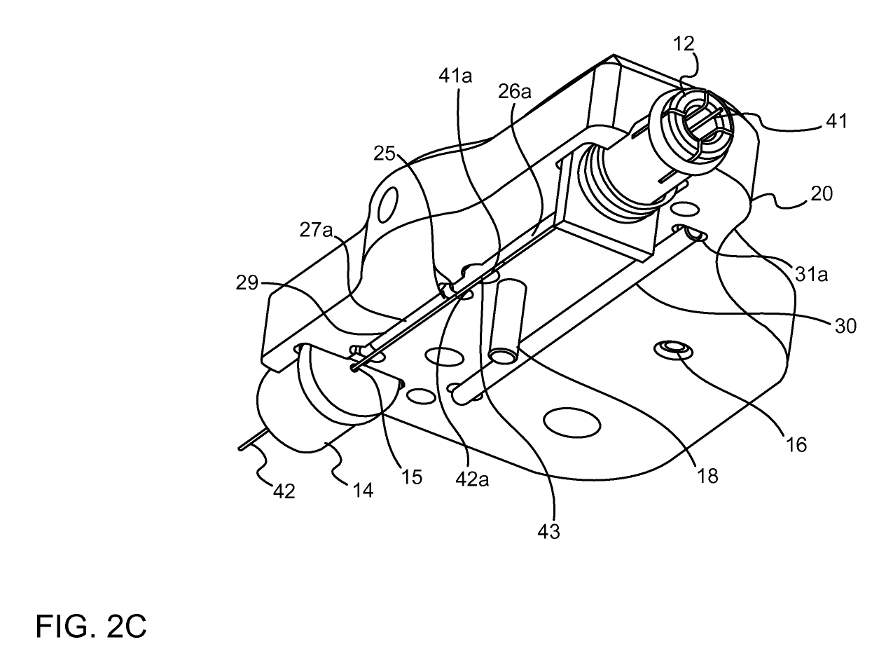

FIG. 1A shows a fiber coupler, in accordance with embodiments of the present invention. Fiber coupler 10 is constructed of two plates, plate 20 and plate 22. Screw 18 is inserted through recessed hole of plate 20 and affixed to plate 22. The structure of recessed hole 19 is such as to allow a small amount of movement along the axis of screw 18. Thus, when plates 20 and 22 are pressed together, for example, on or near finger pads 16 (the second finger pad, not shown, is located opposite the indicated finger pad 16 on the outer surface of plate 22), gap 21 opens slightly. When gap 21 opens slightly, side 20a of plate 20 separates by a small distance from side 22a of plate 22. Separation of side 20a from side 22a, compresses O-ring 24 (visible in FIG. 2A), or an equivalent deformable elastic element such as a spring, between the head of screw 18 and structure within recessed hole 19. Compressed O-ring 24 provides an elastic restoring force that tends to re-close gap 21 when the force pressing finger pads 16 together is reduced. The end of a first fiber may be inserted through spring-loaded fiber port 12. The end of a second fiber to be coupled to the first may be inserted through fixed fiber port 14. Opening gap 21 and separating a part of plate 20 from a corresponding part of plate 22 may facilitate insertion of the fibers by reducing frictional motion-resisting forces on the fibers.

FIG. 1B shows the fiber coupler of FIG. 1A with fibers inserted. A first fiber is inserted into spring-loaded fiber port 12. Typically, a first fiber that is inserted into spring-loaded fiber port 12 is provided with attached connecting structure, such as fiber connector 40. Fiber connector 40 attaches to spring-loaded fiber port 12. Therefore, when a force is applied longitudinally to the first fiber, the force is transmitted to spring-loaded fiber port 12 via fiber connector 40. Similarly, a longitudinal force applied by an urging mechanism, such as a spring, of spring-loaded fiber port 40 may be transmitted or applied to the first fiber. Second fiber 42, is inserted into fixed fiber port 14.

Plate 20, plate 22, or both, may be fully or partially constructed out of a transparent, or partially transparent, material, such as a transparent plastic. Construction of part or all of plate 20 or 22 out of a transparent material may enable at least limited viewing of the positions of internal components. Viewing of internal components may facilitate verification of proper insertion and coupling of fibers in fiber coupler 10.

FIG. 2A shows the fiber coupler of FIG. 1A with a plate removed, illustrating internal structure. FIG. 2B shows the internal structure shown in FIG. 2A with more elements removed, further illustrating the arrangement of internal elements. FIG. 2C is view of the internal structure of FIG. 2A, viewed from a different perspective and with a different plate removed.

Plates 20 and 22 are held together by screw 18. Screw 18 passes through recessed hole 17 in plate 20 and into tapped hole 17 in plate 22. Rod 30 is confined by grooves 31a and 31b and maintains a separation between plates 20 and 22. Thus, rod 30 serves as a fulcrum about which plates 20 and 22 may pivot relative to one another. Recessed hole 17 is shaped such that plates 20 and 22 are free to pivot by a limited amount about rod 30.

Rod segment 26a extends partially along the length of, and is confined by, narrow groove 29 in plate 20. Rod segments 26b and 26c similarly extend along, and are confined side-by-side by, wide groove 28 in plate 22. Thus, when the two plates are held together, rod segments 26 are confined to a triangular arrangement, with central space 38 between rod segments 26. Fiber 41, which is inserted through spring-loaded fiber port 12, may be held in central space 38 between rod segments 26. Fiber 41 may be confined by tangential contact with surrounding rod segments 26. Similarly, rod segments 27a, 27b, and 27c extend along the remaining lengths of, and are held in a triangular arrangement by, narrow groove 29 and wide groove 28, with space 39 between rod segments 27. Fiber 42, which is inserted through fixed fiber port 14, may be held and confined in space 39 between rod segments 27. Alternatively, a single set of three parallel rod segments may be provided, where each cylinder extends the entire length of narrow groove 29 or of wide groove 28.

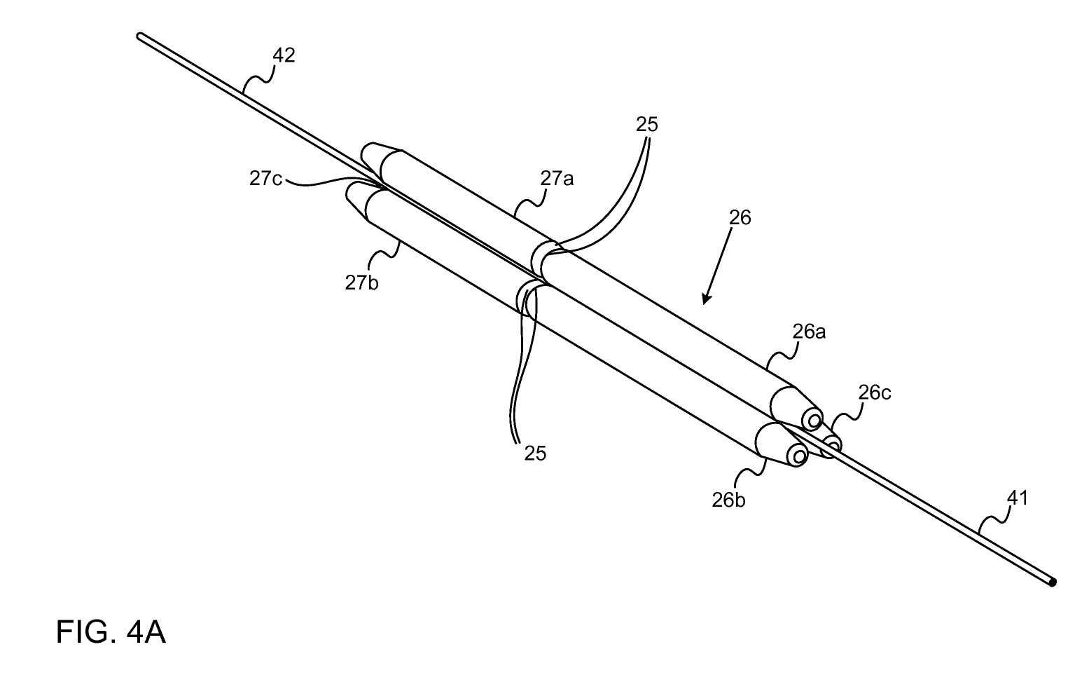

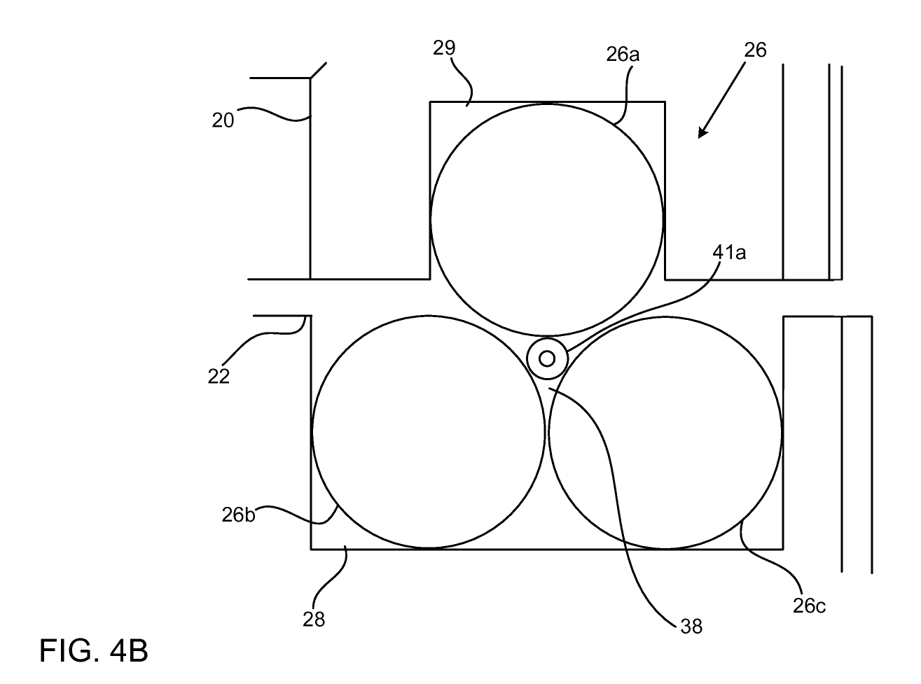

The diameters of all rod segments of rod segments 26 and 27 are typically equal. The diameter may be selected such as to confine a fiber with a specific diameter, or a diameter in a specific range of diameters. For example, if the diameters of rod segments 26 are equal to one another, and rod segments 26 are mutually tangent (in an equilateral triangular arrangement) when confining the fiber (and similarly for rod segments 27), the required cylinder diameter is approximately 6.464 times the diameter of the confined fiber. Alternatively, the cylinder diameter may be less than this value. For example, a cylinder diameter of about 2 mm may be selected for coupling a pair of fibers with outer diameter (typically the diameter of a protective enclosing ferrule) of about 0.36 mm. In this case, rod segments 26b and 26c (and rod segments 27b and 27c) may be confined by wide groove 28 (see FIG. 4B) so as to form a groove with a V-shaped profile that constrains the lateral motion of fiber 41 (or fiber 42). Rod segments 26b and 26c may be confined by wide groove 28 so as to be tangent to one another. Rod segment 26a (or rod segment 27a), confined by narrow groove 29, limits the motion of fiber 41 such that it cannot move out of the V-shaped groove formed by rod segments 26b and 26c.

Alternatively, the diameters of the rod segments making up each collinear pair of rod segments, rod segments 26a and 27a, rod segments 26b and 27b, and rod segments 26c and 27c, may be separately equal to one another, but not necessarily to the diameter of a rod segment of another pair.

Typically, when using fiber coupler 10 to couple two fibers, such as fibers 41 and 42, an end of fiber 41 is first inserted into spring-loaded fiber port 12 into central space 38 between rod segments 26. Fiber 41, which is inserted into spring-loaded fiber port 12, is typically provided with a fiber connector, such as fiber connector 40. Fiber 41 is then inserted until fiber connector 40 connects to spring-loaded fiber port 12. The inserted end may be inserted between rod segments 26 so as to enable ferrule 41a at the end of fiber 41 to be firmly grasped by rod segments 26. An end of fiber 42 may then be inserted into aperture 15 of fixed fiber port 14, and into space 39 between rod segments 27. The end of fiber 42 may be inserted until the distal end of ferrule 42a at the end of fiber 42 contacts the distal end of ferrule 41a at splice point 43. Typically, splice point 43 lies between rod segments 26. Ends 25 of rod segments 26 and 27, which are typically located near splice point 43, may be tapered. The proximal end of ferrule 42a typically lies at ends 25 when fiber 42 is fully inserted. The taper at ends 25 may accommodate slight lateral imperfections at the proximal end of ferrule 42a. An accommodated imperfection may include, for example, excess glue in the end of a protective ferrule surrounding the proximal end of ferrule 42a.

Typically, contact is made between fiber ends that are surrounded by protective ferrules, such as ferrules 41a and 42a. When contact is made, further insertion of fiber 42 may push fiber 41 backward, out of fiber coupler 10. Pushing fiber 41 backward may push fiber connector 40 backward. Pushing fiber connector 40 backward may pull spring-loaded fiber port 12 in a direction away from fiber coupler 10. Pulling spring-loaded fiber connector 12 away from fiber coupler 10 compresses spring 32, or an equivalent element capable of applying a restoring force. Motion of spring-loaded fiber connector 12 is limited by confinement of plunger 34 to groove 36. At this point, when contact is made between the ends of the inserted fibers, rod segments 27 may hold fiber 42 in place, and the insertion force pushing the end of fiber 42 into the end of fiber 41 may be relaxed. The urging force applied by the restoring force of spring 32 may then pull fiber connector 40 and fiber 41 inward, holding the end of fiber 41 firmly against the end of fiber 42. Holding the end of fiber firmly 41 against the end of fiber 42 may prevent the formation of a gap between the two ends at point 43, and may maintain good contact between fibers 41 and 42.

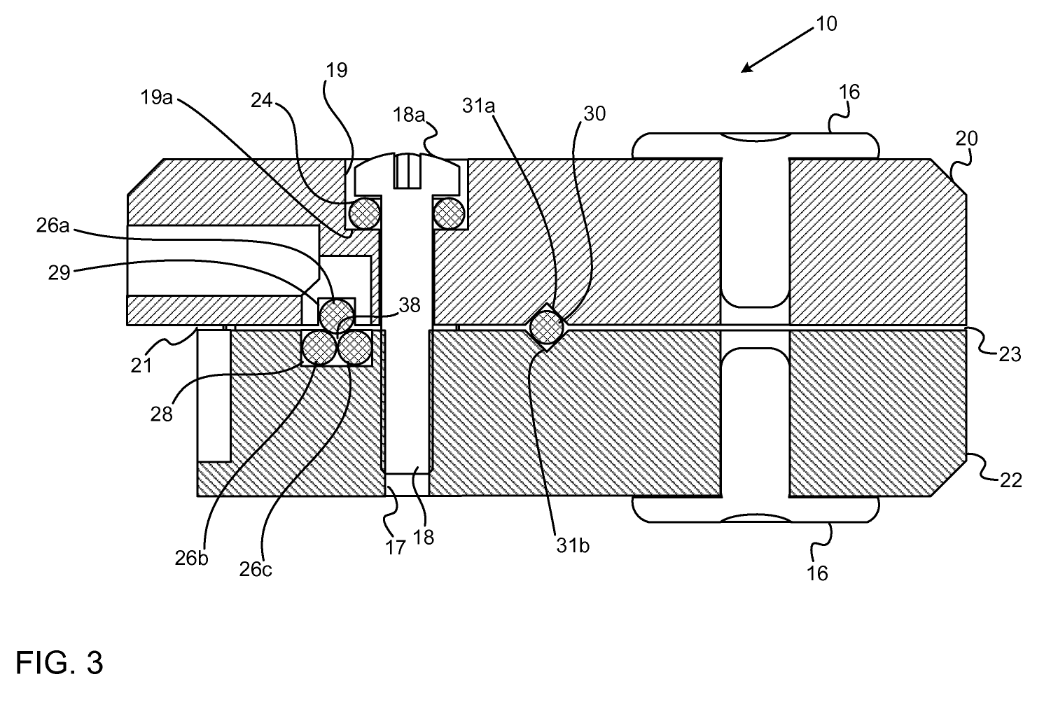

In order to facilitate insertion of a fiber between rod segments 26 or 27, the size of central space 38 or 39 between the rod segments may be temporarily increased to substantially more than the diameter of the fiber. FIG. 3 shows a cross section of the optical fiber coupler shown in FIG. 1A. The section shown passes through finger pads 16 and screw 18. Pressing finger pads 16 toward one another pivots plates 20 and 22 about rod 30, increasing the width of gap 21 and decreasing the width of gap 23 on the opposite side of rod 30. The pivoting motion compresses O-ring 24 between bottom surface 19a of recessed hole 19 and head 18a of screw 18. When the width of gap 21 is increased, the distance between narrow groove 29 and wide groove 28 also is increased. Increasing the distance relaxes the confinement of rod segments 26 and 27, facilitating the insertion of a fiber into central space 38 between rod segments 26 (or into space 39 between rod segments 27). Once the fiber is inserted, pressure on finger pads 16 may be released. When pressure on finger pads 16 is released, O-ring 24 expands to its uncompressed state, closing gap 21 (while opening gap 23) and reducing the size of central space 38 between rod segments 26 (and of space 39 between rod segments 27). Thus, O-ring 24 applies a force to narrow groove 29 and wide groove 28, together forming a pressing mechanism that may press on rod segments 26 and 27.

FIG. 4A shows two fibers being held by rod segments, in accordance with embodiments of the present invention. Fiber 41 is inserted between rod segments 26. Fiber 42 is inserted between rod segments 27, and extends to between rod segments 26. FIG. 4B is a cross-section through the rod segments shown in FIG. 4A. The cross section shown passes through rod segments 26 and ferrule 41a (at the end of fiber 41), and is perpendicular to the axes of the rod segments. (A cross section through rod segments 26, or through the ferrule at the end of fiber 42 would look identical.) The diameters of rod segments 26, as well as confinement of rod segment 26a by narrow groove 29 in plate 20, and of rod segments 26b by wide groove 28 in plate 22, determine the size of central space 38. The size of central space 38 is such that ferrule 41a is held such that ferrule 41a is tangent to rod segments 26. Thus, ferrule 41a is held at a precise lateral position between rod segments 26. For example, the precision of the lateral placement of a fiber held between rod segments 26 may be approximately 1 micron.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An optical fiber coupler apparatus for coupling ends of a first and second optical fiber of a substantially equal diameter, the apparatus comprising:
three cylindrical rods, whose longitudinal axes are substantially parallel and in a triangular arrangement;
a pressing mechanism for pressing the rods together, forming a central space that is substantially parallel to the axes, such that an end of the first optical fiber that is inserted into one end of the central space is held substantially collinearly with an end of the second optical fiber that is inserted into an opposite end of the central space; and
an urging mechanism for urging the inserted end of the first optical fiber against the inserted end of the second optical fiber.

2. An apparatus as claimed in claim 1, wherein a rod of said three cylindrical rods comprises two collinear rod segments.

3. An apparatus as claimed in claim 1, wherein the diameters of the rods are substantially equal.

4. An apparatus as claimed in claim 1, wherein the pressing mechanism comprises two plates that are pressed together.

5. An apparatus as claimed in claim 4, wherein one plate of said two plates is provided with a wide groove for confining two rods of said three cylindrical rods, and the other plate of said two plates is provided with a narrow groove for confining one rod of said three cylindrical rods.

6. An apparatus as claimed in claim 4, comprising an elastic element for pressing the plates together.

7. An apparatus as claimed in claim 6, wherein the elastic element comprises an O-ring.

8. A method for coupling ends of a first and second optical fibers of a substantially equal diameter, the method comprising:
providing three cylindrical rods, whose longitudinal axes are substantially parallel and in a triangular arrangement;
providing a pressing mechanism for pressing the rods together, forming a central space that is substantially parallel to the axes;
providing an urging mechanism for urging the inserted end of the first optical fiber against the inserted end of the second optical fiber;
inserting an end of the first optical fiber into one end of the central space and an end of the second optical fiber into an opposite end of the central space until the inserted ends meet;
operating the pressing mechanism to press the rods together such that the inserted end of the first optical fiber is held substantially collinearly with the inserted end of the second optical fiber; and
operating the urging mechanism to urge the inserted end of the first optical fiber against the inserted end of the second optical fiber.

9. A method as claimed in claim 8, wherein the step of inserting an end of the first optical fiber and of inserting an end of the second optical fiber comprises increasing a dimension of the central space in a plane that is substantially perpendicular to the longitudinal axes.

10. A method as claimed in claim 9, wherein the pressing mechanism comprises two plates that are pressed together, and the step of increasing a dimension of the central space comprises increasing the distance between the plates.
